(19) United States
(12) Patent Application Publication
(10) Pub. No.: US 2026/0284687 A1
(43) Pub. Date: Sep. 24, 2026

(54) LIQUID EJECTION APPARATUS

(71) Applicants: Tomoya TANAKA, Tokyo (JP); Shogo MIURA, Tokyo (JP); Natsumi HAYASHI, Tokyo (JP); Nils BRUECKMANN, Aachen (DE); Burkhard CORVES, Aachen (DE); Mathias HUESING, Aachen (DE); Thomas KNOBLOCH, Aachen (DE); Christian MIRZ, Aachen (DE); INSTITUTE OF SCIENCE TOKYO, Tokyo (JP)

(72) Inventors: Tomoya TANAKA, Kanagawa (JP); Shogo MIURA, Kanagawa (JP); Natsumi HAYASHI, Tokyo (JP); Yukio TAKEDA, Tokyo (JP); Yusuke SUGAHARA, Tokyo (JP); Ming JIANG, Tokyo (JP); Koichi KATO, Tokyo (JP); Ryota SHIOYA, Tokyo (JP); Shota FUJISAKA, Tokyo (JP); Hiroaki NAGATA, Tokyo (JP); Katsuki EMA, Tokyo (JP); Masashi YOSHII, Tokyo (JP); Nils BRUECKMANN, Aachen (DE); Burkhard CORVES, Hergenrath (BE); Mathias HUESING, Aachen (DE); Thomas KNOBLOCH, Aachen (DE); Christian MIRZ, Aachen (DE)

(73) Assignees: Ricoh Company, Ltd., Tokyo (JP); RWTH Aachen University, Aachen (DE)

(21) Appl. No.: 19/546,545

(22) Filed: Feb. 23, 2026

(30) Foreign Application Priority Data
Mar. 21, 2025 (JP) 2025-047252

(51) Int. Cl. B05B 13/04

(52) U.S. Cl. CPC B05B 13/0415

(57) ABSTRACT

A liquid ejection apparatus includes a liquid ejection head, a holder, a conveyance guide, a first posture adjustment guide, a second posture adjustment guide, and two couplers. The liquid ejection head ejects liquid to a target object. The holder holds the liquid ejection head or the target object. The conveyance guide allows the liquid ejection head to move with respect to the target object. Each of the first and second posture adjustment guides extends in a predetermined extending direction, supports the conveyance guide, and allows the conveyance guide to move in the extending direction. The two couplers couple each of the first and second posture adjustment guides to the conveyance guide. The first and second posture adjustment guides are adjacent to both ends of the conveyance guide and support neighboring portions of the both ends via the two couplers.

### CROSS-REFERENCE TO RELATED APPLICATION

The present application claims priority under 35 U.S.C. § 119 to Japanese Patent Application No. 2025-047252, filed on Mar. 21, 2025. The contents of which are incorporated herein by reference in their entirety.

### BACKGROUND OF THE INVENTION

### 1. Field of the Invention

The present invention relates to a liquid ejection apparatus.

### 2. Description of the Related Art

A technology for causing an industrial robot to hold and convey a liquid ejection head to paint a target object having a three-dimensional shape is known.

As a painting system using the industrial robot as described above, a configuration is disclosed, in which, in a control apparatus of an inkjet print that includes a print head for ejecting ink onto a surface of a three-dimensional object and an imaging unit for imaging the surface of the three-dimensional object so as to include an edge portion of a single image among a plurality of painted images, the inkjet printer includes a control unit that paints the plurality of images in an adjacent manner and corrects data based on the image that is captured by the imaging unit, where the control unit controls the print head so as to eject ink based on the corrected data such that even when the plurality of images are painted in an adjacent manner on the surface of the three-dimensional object, it is possible to continuously perform painting while preventing an unpainted area and an overlapping area from being generated in adjacent side surface portions of the images (for example, Japanese Unexamined Patent Application Publication No. 2021-079384).

However, in the technology described in Japanese Unexamined Patent Application Publication No. 2021-079384, the liquid ejection head is held by a robot arm in a cantilever manner, and therefore, rigidity of a component that holds the liquid ejection head is reduced and the liquid ejection head is more likely to oscillate at the time of conveyance.

### SUMMARY OF THE INVENTION

According to an aspect of the present invention, a liquid ejection apparatus includes a liquid ejection head, a holder, a conveyance guide, a first posture adjustment guide, a second posture adjustment guide, and two couplers. The liquid ejection head is configured to eject a liquid to a target object. The holder is configured to hold the liquid ejection head or the target object. The conveyance guide is configured to allow the liquid ejection head to move with respect to the target object. The first posture adjustment guide extends in a predetermined extending direction and supports the conveyance guide. The first posture adjustment guide is configured to allow the conveyance guide to move in the extending direction. The second posture adjustment guide extends in the predetermined extending direction and supports the conveyance guide. The second posture adjustment guide is configured to allow the conveyance guide to move in the extending direction. The two couplers are configured to couple each of the first posture adjustment guide and the second posture adjustment guide to the conveyance guide. The first posture adjustment guide and the second posture adjustment guide are adjacent to both ends of the conveyance guide and support neighboring portions of the both ends via the two couplers.

### BRIEF DESCRIPTION OF THE DRAWINGS

FIG. 1 is a diagram illustrating an example of an overall configuration of a liquid ejection apparatus according to a first embodiment;

FIG. 2 is a diagram illustrating an example of a configuration of a painting robot unit according to the first embodiment;

FIG. 3 is a diagram illustrating an example of the configuration of the painting robot unit according to the first embodiment when viewed from a longitudinal direction of a target object;

FIG. 4 is a diagram illustrating an example of a configuration of an inkjet head of the painting robot unit according to the first embodiment;

FIG. 5 is a cross-sectional view of the inkjet head of the painting robot unit according to the first embodiment;

FIG. 6 is a diagram illustrating an example of a configuration of a supply unit according to the first embodiment;

FIG. 7 is a diagram illustrating an example of a detailed configuration of a coupling unit of the painting robot unit according to the first embodiment;

FIG. 8 is a diagram illustrating an example of a hardware configuration of the painting system according to the first embodiment;

FIG. 9 is a diagram illustrating an example of a functional block configuration of a controller of a control unit of the liquid ejection apparatus according to the first embodiment;

FIG. 10 is a diagram illustrating an example of scanning operation the inkjet head of the liquid ejection apparatus according to the first embodiment;

FIG. 11 is a diagram for explaining operation of preventing oscillation of the inkjet head in the liquid ejection apparatus according to the first embodiment;

FIG. 12 is a diagram illustrating an example of a detailed configuration a coupling unit of a painting robot unit according to a first modification of the first embodiment;

FIG. 13 is a diagram illustrating an example of a configuration of a painting robot unit according to a second modification of the first embodiment;

FIG. 14 is a diagram illustrating an example of a configuration of a painting robot unit according to a third modification of the first embodiment;

FIG. 15 is a diagram illustrating an example of a configuration of a painting robot unit according to a fourth modification of the first embodiment; and

FIG. 16 is a diagram illustrating an example of a configuration of a painting robot unit according to the second embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of the present invention is to provide a liquid ejection apparatus that is able to prevent oscillation of a liquid ejection head that occurs when the liquid ejection head moves, and improve painting accuracy.

Embodiments of a liquid ejection apparatus according to the present invention will be described in detail below with reference to the drawings. The present invention is not limited by the embodiments below, and components of the embodiments below include one that can easily be thought of by a person skilled in the art, one that is practically identical, and one that is within an equivalent range. In addition, within the scope not departing from the gist of the following embodiments, various omission, replacement, and modifications of the components may be made.

### First Embodiment

### Overall Configuration of Liquid Ejection Apparatus

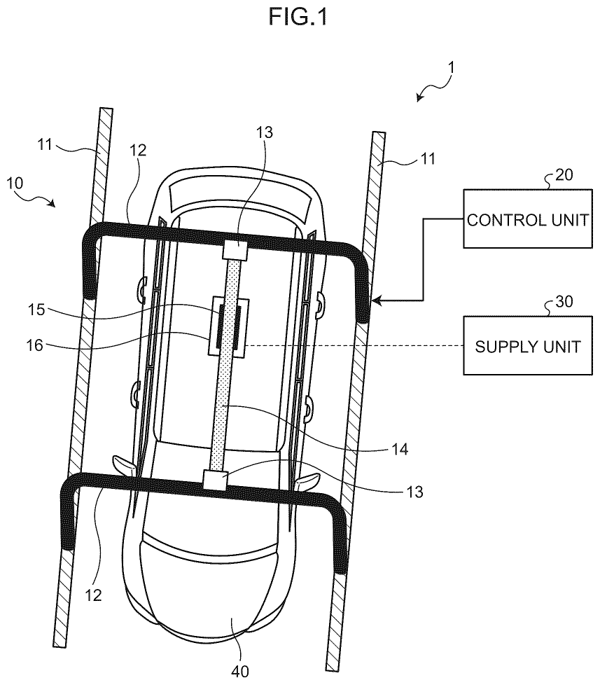

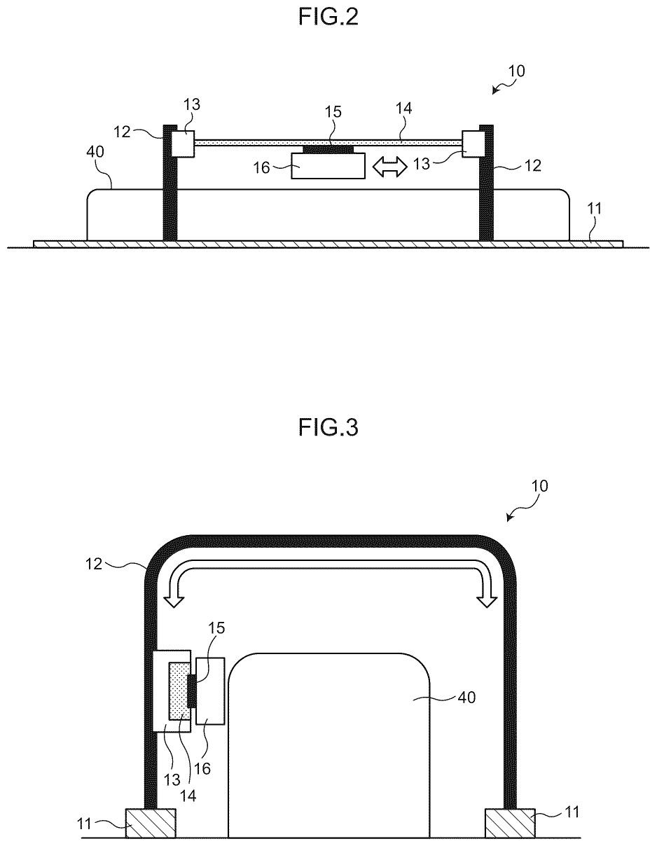

FIG. 1 is a diagram illustrating an example of an overall configuration of a liquid ejection apparatus according to a first embodiment. FIG. 2 is a diagram illustrating an example of a configuration of a painting robot unit according to the first embodiment. FIG. 3 is a diagram illustrating an example of the configuration of the painting robot unit according to the first embodiment when viewed from a longitudinal direction of a target object. With reference to FIG. 1 to FIG. 3, an overall configuration and overall operation of a liquid ejection apparatus 1 according to the first embodiment will be described.

The liquid ejection apparatus 1 illustrated in FIG. 1 is an apparatus that forms an image by ejecting and applying a liquid, such as ink, to a target object 40 that is a painting target. The liquid ejection apparatus 1 includes, as illustrated in FIG. 1, a painting robot unit 10, a control unit 20, and a supply unit 30.

The painting robot unit 10 is a robot apparatus that is arranged so as to surround the target object 40 and causes an inkjet head 16 to perform scanning and eject a liquid to perform painting on a surface of the target object 40. The painting robot unit 10 includes, as illustrated in FIG. 1 to FIG. 3, two conveyance devices 11, two posture adjustment guides 12, two coupling units (couplers) 13, a uniaxial conveyance guide 14 (conveyance guide), a head holding unit 15 (one example of a holding unit or a holder), and the inkjet head 16.

The target object 40 is, for example, a body of a vehicle, an airplane, a ship, or the like. The vehicle includes an automobile, a track, a train, and the like. In the example illustrated in FIG. 1, the target object 40 is a vehicle.

The conveyance devices 11 are slider devices, such as single-axis robots, that are fixed to the ground or the like and support the two posture adjustment guides 12 such that the posture adjustment guides 12 are able to move back and forth in one direction. Meanwhile, a posture of the inkjet head 16 indicates a posture and an angle of the inkjet head 16 relative to the target object 40. As illustrated in FIG. 1 and FIG. 3, the conveyance devices 11 support, from below, both ends of the posture adjustment guides 12 having arch shapes. Therefore, as illustrated in FIG. 1 and FIG. 3, the conveyance devices 11 are two, adjacent to two sides of the target object 40 in a short-axial direction, and extending along a long-axial direction of the target object 40.

Meanwhile, it is assumed that the conveyance devices 11 support the both ends of the posture adjustment guides 12 having the arch shapes, but embodiments are not limited to the configuration that support the both ends, and it may be possible to adopt a configuration that supports neighboring portions of the both ends of the posture adjustment guides 12.

The posture adjustment guides 12 are guide members that have the arch shapes as illustrated in FIG. 3, that are adjacent to both ends of the uniaxial conveyance guide 14, and that support neighboring portions of the both ends via the two coupling units 13. The posture adjustment guides 12 extend in a predetermined direction and support the uniaxial conveyance guide 14 such that the uniaxial conveyance guide 14 is able to move back and forth along the arch shapes (along an extending direction) as illustrated in FIG. 3. Therefore, the posture adjustment guides 12 are two, each being constituted by a combination of one or more linear members and one or more arc-shaped members as illustrated in FIG. 3. Specifically, each of the posture adjustment guides 12 includes linear members and an arc-shaped member that is between the linear members as a joint.

If, hypothetically, each of the posture adjustment guides 12 is made by combining linear members only, movement of the coupling units 13 is discontinued at joint portions of the linear members, so that the posture of the inkjet head 16 becomes unstable and a singular point at which the posture is largely changed occurs. At the singular point, the posture of the inkjet head 16 is suddenly changed and remains unstable, which causes deviation of a landing position on the target object 40 when the inkjet head 16 ejects a liquid, such as ink. However, as described above, each of the posture adjustment guides 12 is made by combining one or more linear members and one or more arc-shaped members, so that the coupling units 13 are able to continuously move back and forth on the posture adjustment guides 12, the posture of the inkjet head 16 is stabilized, and it is possible to improve accuracy of the landing position.

Meanwhile, the posture adjustment guides 12 are constituted by a combination of one or more linear members and one or more arc-shaped members, but embodiments are not limited to this example, and the posture adjustment guides 12 may be constituted by an arc-shaped member only (for example, a semicircular member). Even in this case, the coupling units 13 are able to continuously move back and forth on the posture adjustment guides 12, so that it is possible to stabilize the posture of the inkjet head 16 and improve accuracy of the landing position.

Furthermore, the posture adjustment guides 12 support the both ends of the uniaxial conveyance guide 14, but embodiments are not limited to the configuration for supporting the both ends, and it may be possible to adopt a configuration for supporting neighboring portions of the both ends of the uniaxial conveyance guide 14.

Moreover, the two posture adjustment guides 12 correspond to a “first posture adjustment guide” and a “second posture adjustment guide” of an embodiment of the present invention.

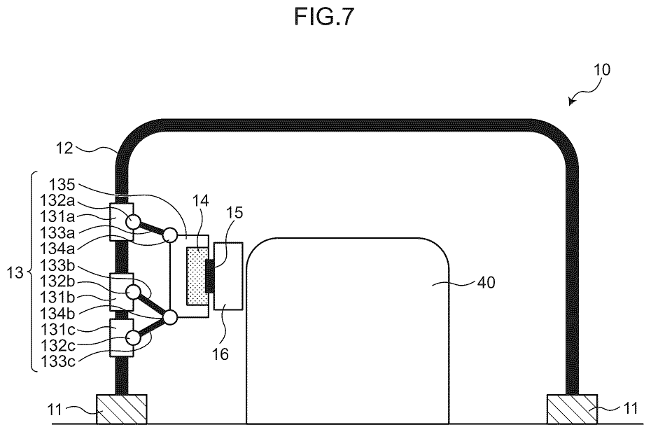

The coupling units 13 are members that are arranged at the both ends of the uniaxial conveyance guide 14 and couple the uniaxial conveyance guide 14 to the two posture adjustment guides 12. Therefore, the coupling units 13 are two, supported by the two posture adjustment guides 12 in a movable manner, and move along the arch shapes of the posture adjustment guides 12. With this configuration, the uniaxial conveyance guide 14 is able to move along the arch shapes of the posture adjustment guides 12. Furthermore, as will be described later, the coupling units 13 are configured to adjust a position of the inkjet head 16 (a distance from the inkjet head 16 to the target object 40) and an angle of the inkjet head 16 (an angle of an ejection surface of the inkjet head 16 relative to a surface of the target object 40). Specifically, the coupling units 13 are able to change a relative position and a relative angle between the inkjet head 16 and the target object 40, change a liquid ejection direction of the inkjet head 16, and cause a nozzle surface of the inkjet head 16 to face the target object 40. Meanwhile, a specific configuration of the coupling units 13 will be described later with reference to FIG. 7.

Meanwhile, the coupling units 13 are arranged at the both ends of the uniaxial conveyance guide 14, but embodiments are not limited to the configuration in which the coupling units 13 are arranged at the both ends, and the coupling units 13 may be arranged in neighboring portions of the both ends of the uniaxial conveyance guide 14.

The uniaxial conveyance guide 14 is a guide member that has a function to cause the inkjet head 16 to perform scanning along the surface of the target object 40 as illustrated in FIG. 2 when painting is performed on the target object 40 by the inkjet head 16. Further, as illustrated in FIG. 1 to FIG. 3, the uniaxial conveyance guide 14 holds the inkjet head 16 via the head holding unit 15 so as to allow movement (scanning) of the inkjet head 16. Furthermore, the uniaxial conveyance guide 14 is supported by the two posture adjustment guides 12 via the coupling units 13 that are arranged at the both ends of the uniaxial conveyance guide 14, and is supported so as to be movable along the arch shapes of the posture adjustment guides 12. Meanwhile, scanning of the inkjet head 16 by the uniaxial conveyance guide 14 is one example of operation of moving the inkjet head 16 relative to the target object 40.

Meanwhile, as illustrated in FIG. 1 to FIG. 3, the uniaxial conveyance guide 14 is formed in a linear shape and causes the inkjet head 16 to perform scanning linearly, but embodiments are not limited to this example. For example, FIG. 2 illustrates an example in which the surface of the target object 40 is a planar surface and the uniaxial conveyance guide 14 causes the inkjet head 16 to perform scanning linearly along the surface; however, when the surface of the target object 40 is a non-planar surface, it may be possible to form the uniaxial conveyance guide 14 in a certain shape that conforms to the non-planer surface and the uniaxial conveyance guide 14 may cause the inkjet head 16 to perform scanning along the non-planar surface.

The head holding unit 15 is a member that holds the inkjet head 16 onto the uniaxial conveyance guide 14 such that the uniaxial conveyance guide 14 is able to cause the inkjet head 16 to perform scanning.

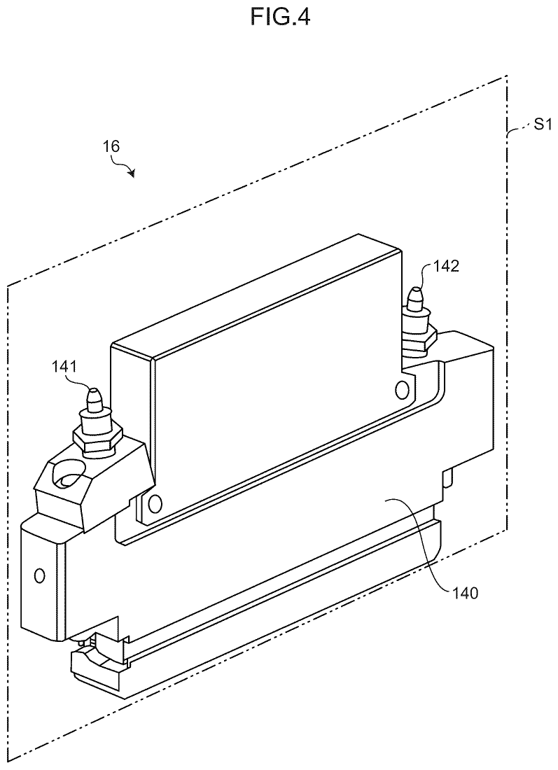

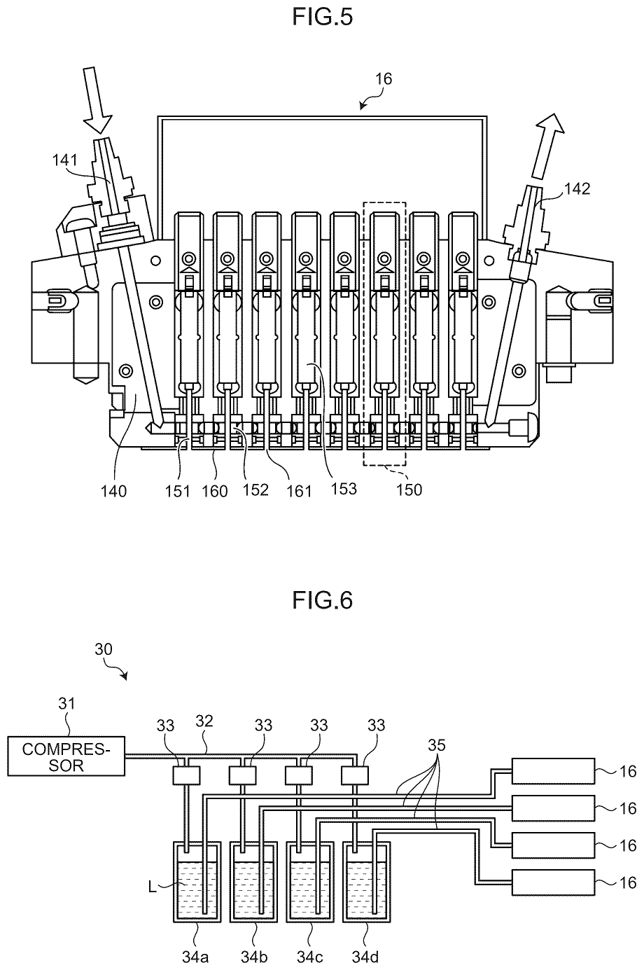

The inkjet head 16 is a liquid ejection head that includes a nozzle surface on which a plurality of nozzles for ejecting a liquid, such as ink, are formed, and is held on the uniaxial conveyance guide 14 by the head holding unit 15 as illustrated in FIG. 2 and FIG. 3. The inkjet head 16 that is held by the head holding unit 15 is caused to perform scanning by the uniaxial conveyance guide 14 and ejects a liquid from the nozzles, so that it is possible to perform painting on the target object 40. Meanwhile, a detailed configuration of the inkjet head 16 will be described later with reference to FIG. 4 and FIG. 5.

Meanwhile, the painting robot unit 10 may include, in addition to the components illustrated in FIG. 1 to FIG. 3, a detection device for measuring a position and inclination of the inkjet head 16, detecting a painting start position on the target object 40, and detecting a size of the painting target. In this case, the detection device may be any device as long as the device outputs feature point information on three-dimensional positions of three or more feature points, and may be, for example, a 3D camera, such as a stereo camera, a 3D sensor or a laser displacement meter other than the stereo camera, or the like. When the detection device is a stereo camera, it is possible to acquire a distance image of the target object 40 by a triangulation method based on disparity between captured images obtained by a plurality of cameras, and output the distance image as the feature point information to the control unit 20. Further, when the detection device is a laser displacement meter, it is possible to measure a liquid ejection direction, detect a height of a roof of the target object 40, and detect a curvature of the target object 40.

The control unit 20 is a device or system that controls general operation of the painting robot unit 10. Specifically, the control unit 20 moves, by the conveyance devices 11 and the posture adjustment guides 12, the inkjet head 16 to a target position in a predetermined painting range of the target object 40 based on shape data of the target object that is determined in advance. Further, the control unit 20 maintains, by the coupling units 13, the inkjet head 16 to have a predetermined distance and a predetermined angle relative to the surface of the target object 40 so as to follow the surface, and causes the inkjet head 16 to perform scanning by driving the conveyance devices 11 and eject a liquid from the inkjet head 16. With this configuration, it is possible to perform painting on the surface of the target object 40.

The supply unit 30 is a device or system for supplying, to the inkjet head 16, a liquid that is to be ejected from the inkjet head 16 to the target object 40. Meanwhile, a detailed configuration of the supply unit 30 will be described later with reference to FIG. 6.

Meanwhile, the liquid ejection apparatus 1 may include, in addition to the components illustrated in FIG. 1, for example, a maintenance unit for removing a thickening liquid or a foreign matter that adheres to the nozzle surface of the inkjet head 16 or removing a thickening liquid or a foreign matter that is present inside the inkjet head 16. By adding the maintenance unit as described above, it is possible to prevent abnormal ejection, such as non-ejection, misdirection, or ejection speed fluctuation, of the inkjet head 16, and maintain an ejection state of the inkjet head 16 as a normal state.

In the painting robot unit 10 as illustrated in FIG. 1 to FIG. 3 as described above, the target object 40 is conveyed to a painting position by a target object conveyance device (not illustrated). With respect to the target object 40 that is conveyed by the conveyance devices 11 and the posture adjustment guides 12 to the painting position and then stopped, the coupling units 13 maintain the inkjet head 16 to have the predetermined distance and the predetermined angle relative to the surface of the target object 40 to follow the surface, the uniaxial conveyance guide 14 causes the inkjet head 16 to perform scanning, and the inkjet head 16 ejects a liquid to perform painting. Further, the target object 40 for which the painting is completed is conveyed to the outside of the painting position by the target object conveyance device (not illustrated), and the next target object 40 is conveyed to the painting position.

Furthermore, in the painting robot unit 10, as described above, the posture adjustment guides 12 support the uniaxial conveyance guide 14 so as to sandwich the uniaxial conveyance guide 14 from the both ends via the coupling units 13 in a both-end supported manner, and therefore, as illustrated in FIG. 1, the conveyance devices 11 (or ground), the two posture adjustment guides 12, and the uniaxial conveyance guide 14 form a closed system. With this configuration, rigidity of the painting robot unit 10 is increased as a whole, so that it is possible to stably hold the inkjet head 16 and prevent oscillation of the inkjet head 16 when the uniaxial conveyance guide 14 causes the inkjet head 16 to perform scanning. Moreover, it is possible to increase accuracy of a landing position of the liquid ejected from the inkjet head 16, so that it is possible to improve quality of image to be painted.

Furthermore, in the painting robot unit 10, as illustrated in FIG. 3, the posture adjustment guides 12 having the arch shapes are arranged so as to surround the target object 40, and the both ends of the posture adjustment guides 12 are supported by the two apparatuses devices 11. With this configuration, the arch shapes of the posture adjustment guides 12 and the ground form a closed system, so that it is possible to further increase the rigidity of the painting robot unit 10, and further contribute to prevention of oscillation of the inkjet head 16 when the uniaxial conveyance guide 14 causes the inkjet head 16 to perform scanning.

Moreover, in the painting robot unit 10, as illustrated in FIG. 1 and FIG. 2, the two conveyance devices 11 support the posture adjustment guides 12 such that the posture adjustment guides 12 are able to move back and forth in one direction. With this configuration, it is possible to move the two posture adjustment guides 12 in the extending direction of the conveyance devices 11, so that it is possible to move to a different painting range on the target object 40 and expand a paintable range. Consequently, it becomes possible to perform painting on the target object 40 with a large size. Meanwhile, the painting robot unit 10 need not always include the conveyance devices 11, and it may be possible to adopt a configuration that does not include the conveyance devices 11, that is, a configuration in which both ends of the posture adjustment guides 12 are fixed to the ground.

### Configuration of Inkjet Head

FIG. 4 is a diagram illustrating an example of a configuration of the inkjet head of the painting robot unit according to the first embodiment. FIG. 5 is a cross-sectional view of the inkjet head of the painting robot unit according to the first embodiment. A configuration of the inkjet head 16 of the painting robot unit 10 according to the present embodiment will be described below with reference to FIG. 4 and FIG. 5.

As illustrated in FIG. 4 and FIG. 5, the inkjet head 16 includes a housing 140, a supply port 141, and a collection port 142.

The housing 140 is a main body of the inkjet head 16. As illustrated in FIG. 5, the housing 140 includes, inside thereof, a plurality of ejection modules 150 that are arranged regularly. Further, as illustrated in FIG. 5, a nozzle plate 160 on which a plurality of nozzles 161 for ejecting a liquid to the outside is bonded to an ejection side of the housing 140.

The supply port 141 is a port for supplying an externally pressurized liquid to the ejection modules 150.

The collection port 142 is a port for discharging a non-ejected liquid to the outside when valves of the nozzles 161 are opened.

The ejection modules 150 are modules for ejecting, from the nozzles 161, the liquid that is supplied from the supply port 141. The ejection modules 150 include, as illustrated in FIG. 5, valves 151, a flow path 152, and piezoelectric elements 153.

The valve 151 is one example of a needle-shaped valve body. The valve 151 is driven by the piezoelectric element 153 and moves back and forth in a liquid ejection direction inside the housing 140 to open and close the nozzle 161.

The flow path 152 is a common flow path for conveying the liquid that is supplied from the supply port 141 to the plurality of ejection modules 150 (eight in the example illustrated in FIG. 5) that are arranged in the housing 140.

The piezoelectric element 153 is an element that is deformed by being applied with voltage and ejects, from the nozzle 161, the liquid that is supplied from the supply port 141.

In the inkjet head 16 as described above, the pressurized liquid is supplied from the supply port 141 through the flow path 152 while the valve of the collection port 142 is closed. When the valve 151 is located at a closed position of the nozzle 161, the liquid is not ejected from the nozzle 161. In contrast, when the valve 151 is lifted up by driving the piezoelectric element 153, the valve of the nozzle 161 is opened and the liquid is ejected from the nozzle 161.

### Configuration of Supply Unit

FIG. 6 is a diagram illustrating an example of a configuration of the supply unit according to the first embodiment. A configuration of the supply unit 30 of the liquid ejection apparatus 1 according to the present embodiment will be described below with reference to FIG. 6.

As illustrated in FIG. 6, the supply unit 30 includes a compressor 31, a pipe 32, air regulators 33, liquid tanks 34a to 34d, and tubes 35. Meanwhile, in the example illustrated in FIG. 6, the liquid ejection apparatus 1 includes the four painting robot units 10, and each of the painting robot units 10 includes the inkjet head 16.

The compressor 31 is a compression apparatus that pressurizes (compresses) air and transfers the pressurized air to the liquid tanks 34a to 34d.

The pipe 32 is a pipe for coupling the compressor 31 and the air regulators 33, coupling the air regulators 33 and the liquid tanks 34a to 34d, and transferring the pressurized air supplied from the compressor 31 to the liquid tanks 34a to 34d.

The air regulators 33 are pressure adjustment valves for adjusting pressure of the pressurized air that is supplied from the compressor 31.

The liquid tanks 34a to 34d are airtight containers for storing a liquid L to be ejected to each of the inkjet heads 16.

The tubes 35 are tubes for establishing coupling such that the liquid stored in the liquid tanks 34a to 34d can be distributed to each of the inkjet heads 16.

In the supply unit 30 as described above, firstly, pressurized air that is compressed by the compressor 31 is supplied to the liquid tanks 34a to 34d via the pipe 32. The liquid L that is pressurized by the pressurized air is supplied to an inlet port of each of the inkjet heads 16, and each of the inkjet heads 16 ejects the liquid L from the nozzles 161.

Meanwhile, the liquid tanks 34a to 34d need not always be arranged for the respective inkjet heads 16, and it may be possible to supply the liquid from a single liquid tank to all of the inkjet heads 16.

### Detailed Configuration of Coupling Unit

FIG. 7 is a diagram illustrating an example of a detailed configuration of the coupling unit of the painting robot unit according to the first embodiment. The detailed configuration of the coupling unit 13 of the painting robot unit 10 according to the present embodiment will be described below with reference to FIG. 7.

The coupling unit 13 of the painting robot unit 10 includes, as illustrated in FIG. 7, movement members 131a to 131c, link members 133a to 133c (coupling members), and a guide holding member 135.

The movement members 131a to 131c are members for having the whole coupling unit 13 supported by the posture adjustment guide 12 such that the coupling unit 13 is movable. As illustrated in FIG. 7, among the movement members 131a to 131c, the movement member 131c is the first closest to, the movement member 131b is the second closest to, and the movement member 131a is the third closest to the conveyance device 11 so as to be able to individually move on the posture adjustment guide 12.

The link member 133a is a member for coupling the movement member 131a and the guide holding member 135. Specifically, the link member 133a couples a coupling point 132a of the movement member 131a and a coupling point 134a of the guide holding member 135. Further, the link member 133a is coupled at the coupling point 132a so as to be able to rotate with respect to the movement member 131a while adopting a direction perpendicular to the extending direction of the posture adjustment guides 12 (a direction viewed in the sheet of FIG. 7) as a central axis. Furthermore, the link member 133a is coupled at the coupling point 134a so as to be able to rotate with respect to the guide holding member 135 while adopting the perpendicular direction as a central axis.

The link member 133b is a member for coupling the movement member 131b and the guide holding member 135. Specifically, the link member 133b couples a coupling point 132b of the movement member 131b and a coupling point 134b of the guide holding member 135. Further, the link member 133b is coupled at the coupling point 132b so as to be able to rotate with respect to the movement member 131b while adopting a direction perpendicular to the extending direction of the posture adjustment guides 12 (a direction viewed in the sheet of FIG. 7) as a central axis. Furthermore, the link member 133b is coupled at the coupling point 134b so as to be able to rotate with respect to the guide holding member 135 while adopting the perpendicular direction as a central axis.

The link member 133c is a member for coupling the movement member 131c and the guide holding member 135. Specifically, the link member 133c couples a coupling point 132c of the movement member 131c and the coupling point 134b of the guide holding member 135. Further, the link member 133c is coupled at the coupling point 132c so as to be able to rotate with respect to the movement member 131c while adopting a direction perpendicular to the extending direction of the posture adjustment guides 12 (a direction viewed in the sheet of FIG. 7) as a central axis. Furthermore, the link member 133c is coupled at the coupling point 134b so as to be able to rotate with respect to the guide holding member 135 while adopting the perpendicular direction as a central axis.

The guide holding member 135 is a member for holding the uniaxial conveyance guide 14. Specifically, the guide holding members 135 of the two coupling units 13 hold the both ends of the uniaxial conveyance guide 14.

As described above, the link member 133b and the link member 133c, which are adjacent two link members, are coupled to the common coupling point 134b of the guide holding member 135. Specifically, the link members 133a to 133c are coupled at three points at the side of the movement members 131a to 131c, and at two points at the side of the guide holding member 135. If, hypothetically, the link member 133b and the link member 133c are coupled at different coupling points of the guide holding member 135 instead of the common coupling point 134b (that is, coupled at three points on the guide holding member 135), a positional relationship among the link members 133a to 133c becomes complicated, which makes control complicated. Further, if, hypothetically, the movement member 131b and the link member 133b are not provided (that is, two link members are provided), the degree of freedom of the posture of the guide holding member 135 is excessively increased, so that the postures of the uniaxial conveyance guide 14 and the inkjet head 16 become unstable. In contrast, as described above, by coupling the link members 133a to 133c at the three points on the movement members 131a to 131c and at the two points on the guide holding member 135, it is possible to stabilize the postures of the uniaxial conveyance guide 14 and the inkjet head 16 by a simple configuration.

Furthermore, with the configuration of the coupling units 13 as described above, by controlling intervals between the movement members 131a to 131c, the coupling units 13 are able to change distances between the posture adjustment guides 12 and the uniaxial conveyance guide 14 (a distance between the inkjet head 16 and the target object 40), so that it is possible to adjust the position of the inkjet head 16 in accordance with the shape of the target object 40. Moreover, by controlling the intervals between the movement members 131a to 131c, the coupling units 13 are able to control rotation angles of the link members 133a to 133c at each of the coupling points as described above, so that it is possible to change angles of the posture adjustment guides 12 with respect to the uniaxial conveyance guide 14 and it is possible to adjust the angle of the inkjet head 16 with respect to the target object 40.

Furthermore, as illustrated in FIG. 7, the guide holding member 135 for holding the uniaxial conveyance guide 14 is held by the three link members (the link members 133a to 133c), so that it is possible to have a load applied to the single link member distributed and improve rigidity of the coupling units 13, which contributes to prevention of oscillation of the inkjet head 16.

Moreover, the coupling units 13 configured as described above maintain the position of the inkjet head 16 (a distance between the inkjet head 16 and the target object 40) and the angle (an angle of the inkjet head 16 with respect to the target object 40) in a predetermined state during scanning by the inkjet head 16 using the uniaxial conveyance guide 14. Specifically, the coupling units 13 maintain the posture of the inkjet head 16 so as to prevent at least rolling and yawing with respect to a scanning direction of the uniaxial conveyance guide 14. If, hypothetically, rotation operation, such as rolling or yawing, occurs in the inkjet head 16 at the time of the scanning by the inkjet head 16 (at the time of ejection of the liquid), the inkjet head 16 may oscillate and deviation occurs with respect to an ideal landing position (landing position that is determined in advance) of the liquid, so that a line, unevenness, or the like occurs in a painted image. In contrast, as described above, by maintaining the posture of the inkjet head 16 by the coupling units 13 at the time of scanning of the inkjet head 16 by the uniaxial conveyance guide 14, it is possible to prevent oscillation of the inkjet head 16. Meanwhile, at the time of scanning of the inkjet head 16, the coupling units 13 may allow movement of the inkjet head 16 in the liquid ejection direction of the inkjet head 16, in accordance with the shape of the target object 40.

Meanwhile, FIG. 7 illustrates a configuration in which the link member 133b is coupled to the coupling point 134b of the guide holding member 135, but embodiments are not limited to this example, and it may be possible to adopt a configuration in which the link member 133b is coupled to the coupling point 134a, that is, the link member 133a and the link member 133b are coupled to the common coupling point 134a of the guide holding member 135.

Furthermore, the configuration of the coupling unit 13 is not limited to the example illustrated in FIG. 7; for example, the movement members 131a to 131c may be configured as an integrated member and the integrated member and the guide holding member 135 may be coupled to each other by a link member, such as a parallel link robot (parallel three-point support structure), 3-PPR (Prismatic joints, Prismatic joints, Revolute joint), 2-RRS (Revolute joint, Revolute joint, Spherical joint), RRRU (Revolute joint, Revolute joint, Revolute joint, Universal joint), 2-RPS (Revolute joint, Prismatic joints, Spherical joint), RPRU (Revolute joint, Prismatic joints, Revolute joint, Universal joint), or 3-RR (Revolute joint, Revolute joint).

### Hardware Configuration of Painting System

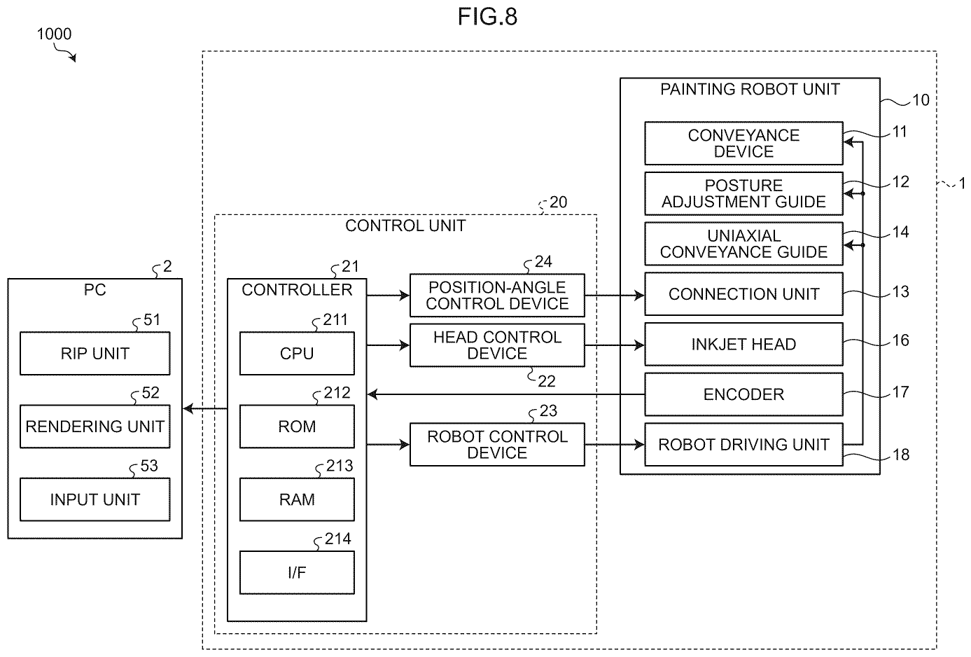

FIG. 8 is a diagram illustrating an example of a hardware configuration of a painting system according to the first embodiment. The hardware configuration of a painting system 1000 according to the present embodiment will be described below with reference to FIG. 8.

As illustrated in FIG. 8, the painting system 1000 includes the liquid ejection apparatus 1 and a personal computer (PC) 2.

The liquid ejection apparatus 1 includes, as illustrated in FIG. 8, the painting robot unit 10 and the control unit 20. The painting robot unit 10 includes the conveyance devices 11, the posture adjustment guides 12, the coupling units 13, the uniaxial conveyance guide 14 (conveyance guide), the inkjet head 16, an encoder 17, and a robot driving unit 18. Meanwhile, operation of the conveyance devices 11, the posture adjustment guides 12, the coupling units 13, the uniaxial conveyance guide 14, and the inkjet head 16 are the same as described above.

The encoder 17 is an apparatus that optically detects a slit that indicates a conveyance position in the conveyance devices 11, the posture adjustment guides 12, and the uniaxial conveyance guide 14. Further, the encoder 17 detects the conveyance position in the conveyance devices 11, the posture adjustment guides 12, and the uniaxial conveyance guide 14, and outputs a detection signal to a controller 21.

The robot driving unit 18 is a driving circuit that operates the conveyance devices 11, the posture adjustment guides 12, and the uniaxial conveyance guide 14 under the control of a robot control device 23.

The control unit 20 includes, as illustrated in FIG. 8, the controller 21, a head control device 22, the robot control device 23, and a position-angle control device 24.

The controller 21 is a control apparatus that controls operation of the painting robot unit 10 via the head control device 22, the robot control device 23, and the position-angle control device 24. The controller 21 includes, as illustrated in FIG. 8, a central processing unit (CPU) 211, a read only memory (ROM) 212, a random access memory (RAM) 213, and an interface (I/F) 214.

The CPU 211 is an arithmetic device that controls the controller 21. The ROM 212 is a non-volatile storage device that is able to store programs and data even when power of the controller 21 is turned off. The ROM 212 may be configured with, for example, a hard disk drive (HDD), a solid state drive (SSD), or the like. The RAM 213 is a volatile storage device that is used as a work area or the like for the CPU 211.

The I/F 214 is a communication interface for inputting and outputting characters, values, various kinds of instructions, and the like to and from an external apparatus, such as the PC 2. The I/F 214 is an interface that is compliant with, for example, Ethernet (registered trademark), Transmission Control Protocol/Internet Protocol (TCP/IP), or the like.

The head control device 22 receives an ejection cycle signal that is output from the controller 21, and controls liquid ejection operation of the inkjet head 16 based on the ejection cycle signal.

The robot control device 23 receives a synchronous control signal that is output from the controller 21, drives the robot driving unit 18 based on the synchronous control signal, and controls operation of the conveyance devices 11, the posture adjustment guides 12, and the uniaxial conveyance guide 14.

The position-angle control device 24 controls operation of adjusting the posture and the angle of the inkjet head 16 by the coupling units 13, under the control of the controller 21 (a position-angle control unit 506 to be described later).

Furthermore, in the control unit 20 illustrated in FIG. 8, the controller 21, the head control device 22, the robot control device 23, and the position-angle control device 24 are configured as different apparatuses, but embodiments are not limited to this example. For example, at least some of the apparatuses may be implemented as a single apparatus.

The PC 2 is an information processing apparatus that performs image processing corresponding to a color profile or a user setting, a rendering process on print data, and the like. The PC 2 includes, as illustrated in FIG. 8, a raster image processor (RIP) unit 51, a rendering unit 52, and an input unit 53.

The RIP unit 51 is a functional unit that performs image processing in accordance with a color profile or a user setting. The rendering unit 52 is a functional unit that divides painting data for performing painting on the target object 40 into pieces of image data for each scan (for example, for each movement in a main-scanning direction of the inkjet head 16). The input unit 53 is an apparatus, such as a keyboard, a mouse, or a touch panel, for receiving operation, such as setting of painting data for performing painting on the target object 40, selection of a painting mode, setting of a painting range (a painting start position, a painting end position, or the like), and a painting instruction.

Meanwhile, the RIP unit 51 and the rendering unit 52 need not always be included in the PC 2, but may be included in the controller 21 of the control unit 20.

Furthermore, the hardware configuration of the painting system 1000 illustrated in FIG. 8 is one example, and it may be possible to add a different component.

### Functional Block Configuration and Operation of Controller of Control Unit

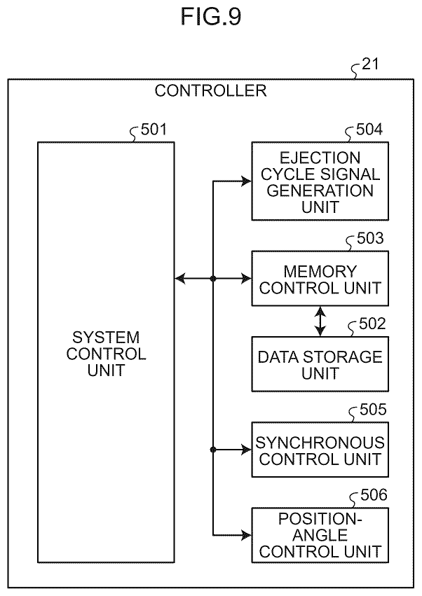

FIG. 9 is a diagram illustrating an example of a functional block configuration of the controller of the control unit of the liquid ejection apparatus according to the first embodiment. The functional block configuration and the operation of the controller 21 of the control unit 20 of the liquid ejection apparatus 1 according to the present embodiment will be described below with reference to FIG. 9.

As illustrated in FIG. 9, the controller 21 of the control unit 20 of the liquid ejection apparatus 1 includes a system control unit 501, a data storage unit 502, a memory control unit 503, an ejection cycle signal generation unit 504, a synchronous control unit 505, and the position-angle control unit 506.

The system control unit 501 is a functional unit that controls general operation of the painting robot unit 10 by using image data of a painting target that is received from the PC 2 via the I/F 214.

The data storage unit 502 is a functional unit that stores therein the image data that is received from the PC 2 via the I/F 214, painting range data for defining a painting range, a program, and the like. The data storage unit 502 is implemented by the ROM 212 and the RAM 213 illustrated in FIG. 8.

The memory control unit 503 is a functional unit that controls read of data from the data storage unit 502, write of data to the data storage unit 502, and the like.

The ejection cycle signal generation unit 504 is a functional unit that generates an ejection cycle signal related to liquid ejection from the inkjet head 16, based on a detection signal received from the encoder 17 and information indicating resolution of the image data that is received from the PC 2 via the I/F 214. The ejection cycle signal generation unit 504 outputs the generated ejection cycle signal to the head control device 22.

The synchronous control unit 505 is a functional unit that generates a synchronous control signal for achieving consistency between operation of the conveyance devices 11, the posture adjustment guides 12, and the uniaxial conveyance guide 14 and the liquid ejection operation of the inkjet head 16. The synchronous control unit 505 outputs the generated synchronous control signal to the robot control device 23.

The position-angle control unit 506 is a functional unit that controls adjustment operation of the coupling units 13 with respect to the position of the inkjet head 16 in accordance with the shape of the target object 40 (a distance between the inkjet head 16 and the target object 40) and the angle of the inkjet head 16 with respect to the target object 40, via the position-angle control device 24.

The system control unit 501, the data storage unit 502, the memory control unit 503, the synchronous control unit 505, and the position-angle control unit 506 as described above are implemented by, for example, causing the CPU 211 illustrated in FIG. 8 to execute a program that is stored in the data storage unit 502. Meanwhile, at least a part of the system control unit 501, the data storage unit 502, the memory control unit 503, the synchronous control unit 505, and the position-angle control unit 506 may be implemented by a hardware circuit, such as a Field-Programmable Gate Array (FPGA) or an Application Specific Integrated Circuit (ASIC).

Meanwhile, each of the functional units of the controller 21 illustrated in FIG. 9 is a conceptual function, and need not always be configured in the manner as described above. In other words, each of the functional units of the controller 21 need not always be configured as a specific software module as a block as illustrated in FIG. 9, but it is satisfactory to implement the functions of the functional units as a whole by causing the CPU 211 of the controller 21 to execute a program. For example, a plurality of functional units illustrated as the individual functional units of the controller 21 illustrated in FIG. 9 may be configured as a single functional unit. In contrast, it may be possible to divide the function of one of the functional units of the controller 21 illustrated in FIG. 9 into a plurality of functions and construct a plurality of functional units for the divided functions.

### Painting Operation of Liquid Ejection Apparatus

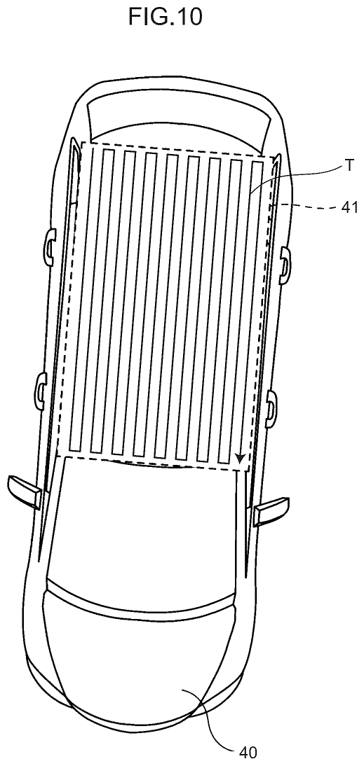

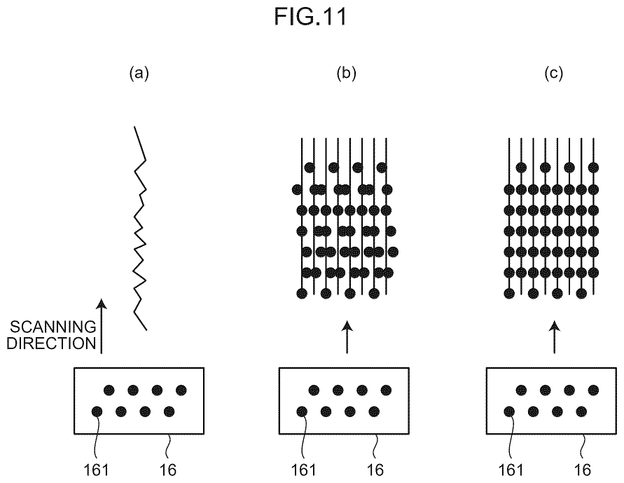

FIG. 10 is a diagram illustrating an example of scanning operation of the inkjet head of the liquid ejection apparatus according to the first embodiment. FIG. 11 is a diagram for explaining operation of controlling oscillation of the inkjet head in the liquid ejection apparatus according to the first embodiment. With reference to FIG. 10 and FIG. 11, the painting operation of the liquid ejection apparatus 1 according to the present embodiment will be described.

A painting range 41 illustrated in FIG. 10 is a range in which the uniaxial conveyance guide 14 of the painting robot unit 10 illustrated in FIG. 1 to FIG. 3 performs scanning with the inkjet head 16 over the target object 40 to perform painting. A scanning path T indicates a path along which the inkjet head 16 is caused to perform scanning with respect to the target object 40. In other words, by repeating the scanning by the inkjet head 16 along the uniaxial conveyance guide 14, it is possible to perform painting throughout the painting range 41.

If, hypothetically, the inkjet head 16 is held by a robot arm in a cantilever manner as in the conventional technology, the rigidity decreases, and oscillation occurs in the component that holds the inkjet head 16, so that, as illustrated in FIG. 11(a), a trajectory of the inkjet head 16 deviates from an ideal trajectory (a path that is determined in advance). When the inkjet head 16 moves while deviating from the ideal trajectory due to oscillation of the inkjet head 16, as illustrated in FIG. 11(b), a landing position of the ink ejected from the nozzles 161 deviate from a predetermined position and a dot is formed, so that adjacent dots deviate from expected positions and are misaligned, which causes a defect, such as a line or unevenness, and reduces quality of an image painted on the target object 40.

In contrast, in the liquid ejection apparatus 1 according to the present embodiment, as described above, the posture adjustment guides 12 support the uniaxial conveyance guide 14 so as to sandwich the uniaxial conveyance guide 14 from the both ends via the coupling units 13 in a both-end supported manner, so that the conveyance devices 11 (or ground), the two posture adjustment guides 12, and the uniaxial conveyance guide 14 form a closed system. With this configuration, rigidity of the painting robot unit 10 is increased as a whole, so that it is possible to stably hold the inkjet head 16 and prevent oscillation of the inkjet head 16 when the uniaxial conveyance guide 14 causes the inkjet head 16 to perform scanning. As a result, as illustrated in FIG. 11(c), the dots are aligned. In other words, it is possible to improve movement accuracy of the inkjet head 16, so that it is possible to improve accuracy of a landing position.

Furthermore, in the painting robot unit 10, as described above, the posture adjustment guides 12 having the arch shapes are arranged so as to cover the target object 40, and the both ends of the posture adjustment guides 12 are supported by the two conveyance devices 11. With this configuration, the arch shapes of the posture adjustment guides 12 and the ground form a closed system, so that it is possible to further increase the rigidity of the painting robot unit 10, and further contribute to prevention of oscillation of the inkjet head 16 when the uniaxial conveyance guide 14 causes the inkjet head 16 to perform scanning.

As described above, in the liquid ejection apparatus 1 according to the present embodiment, the inkjet head 16 ejects the liquid onto the target object 40, the head holding unit 15 holds the inkjet head 16, and the uniaxial conveyance guide 14 has a function to guide scanning (movement) of the inkjet head 16 along the surface of the target object 40 when painting is performed on the target object 40 by the inkjet head 16. The two coupling units 13 couple the two posture adjustment guides 12 to the uniaxial conveyance guide 14, the two posture adjustment guides 12 support neighboring portions of the both ends of the uniaxial conveyance guide 14 via the two coupling units 13 so as to sandwich the both ends. With this configuration, it is possible to increase the rigidity of the painting robot unit 10 as a whole, stably hold the inkjet head 16, and prevent oscillation of the inkjet head 16 when the uniaxial conveyance guide 14 causes the inkjet head 16 to perform scanning. Consequently, it is possible to prevent oscillation of the inkjet head 16 that occurs when the inkjet head 16 moves, and improve painting accuracy.

Furthermore, in the liquid ejection apparatus 1 according to the present embodiment, the two posture adjustment guides 12 have arch shapes so as to cover the target object 40, and are supported by the conveyance devices 11 at both ends thereof. With this configuration, the arch shapes of the posture adjustment guides 12 and the ground form a closed system, so that it is possible to further increase the rigidity of the painting robot unit 10, and further contribute to prevention of oscillation of the inkjet head 16 when the uniaxial conveyance guide 14 causes the inkjet head 16 to perform scanning.

### First Modification

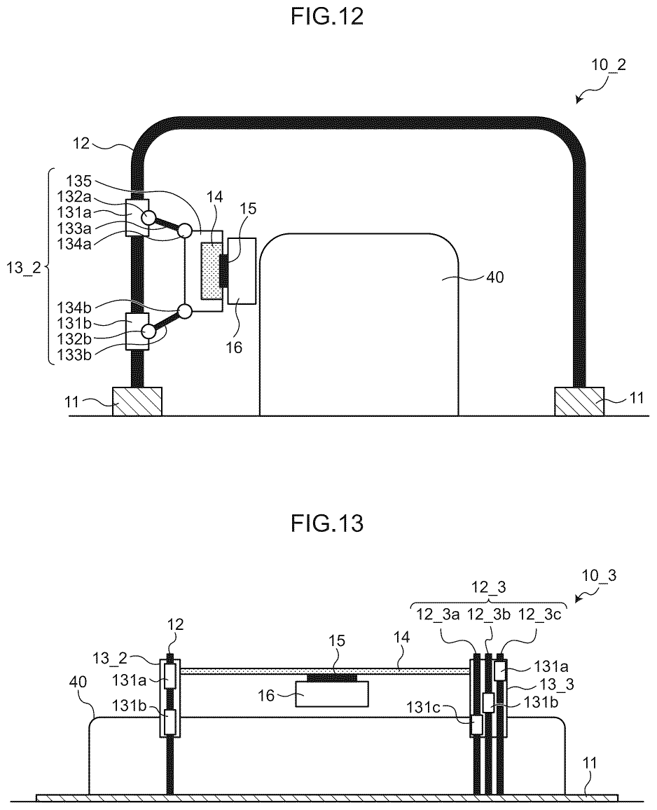

FIG. 12 is a diagram illustrating an example of a detailed configuration of a coupling unit of a painting robot unit according to a first modification of the first embodiment. A configuration of a coupling unit 13_2 of a painting robot unit 10_2 according to the first modification of the present embodiment will be described below with reference to FIG. 12.

In one embodiment as described above, as illustrated in FIG. 7, the coupling unit 13 include the three link members (the link members 133a to 133c). The painting robot unit 10_2 according to the present modification is configured such that one of the two coupling units 13 is replaced with the coupling unit 13_2 as illustrated in FIG. 12.

The coupling unit 13_2 of the painting robot unit 10_2 includes, as illustrated in FIG. 12, the movement members 131a and 131b, the link members 133a and 133b (coupling members), and the guide holding member 135.

The movement members 131a and 131b are members for holding the whole coupling unit 13_2 such that the coupling unit 13_2 is able to move on the posture adjustment guide 12. The movement members 131a and 131b are arranged so as to be able to individually move on the posture adjustment guide 12.

The link member 133a is a member for coupling the movement member 131a and the guide holding member 135. Specifically, the link member 133a couples the coupling point 132a of the movement member 131a and the coupling point 134a of the guide holding member 135. Further, the link member 133a is coupled at the coupling point 132a so as to be able to rotate with respect to the movement member 131a while adopting a direction perpendicular to the extending direction of the posture adjustment guides 12 (a direction viewed in the sheet of FIG. 12) as a central axis. Furthermore, the link member 133a is coupled at the coupling point 134a so as to be able to rotate with respect to the guide holding member 135 while adopting the perpendicular direction as a central axis.

The link member 133b is a member for coupling the movement member 131b and the guide holding member 135. Specifically, the link member 133b couples the coupling point 132b of the movement member 131b and the coupling point 134b of the guide holding member 135. Further, the link member 133b is coupled at the coupling point 132b so as to be able to rotate with respect to the movement member 131b while adopting a direction perpendicular to the extending direction of the posture adjustment guides 12 (a direction viewed in the sheet of FIG. 12) as a central axis. Furthermore, the link member 133b is coupled at the coupling point 134b so as to be able to rotate with respect to the guide holding member 135 while adopting the perpendicular direction as a central axis.

The guide holding member 135 is a member for holding the uniaxial conveyance guide 14. Specifically, the guide holding members 135 of the two coupling units 13 hold the both ends of the uniaxial conveyance guide 14.

Here, in the liquid ejection apparatus 1 according to the embodiment as described above, the coupling units 13 illustrated in FIG. 7 are arranged at the both ends of the uniaxial conveyance guide 14. In this case, an over-constrained state may occur in one of the posture adjustment guides 12. Specifically, when one of the posture adjustment guides 12 determines the posture and the angle of the inkjet head 16 by the coupling unit 13 as illustrated in FIG. 7, and if the coupling unit 13 is used in the same manner in the other one of the posture adjustment guides 12, over-constraint occurs.

In contrast, in the present modification, the coupling unit 13_2 as illustrated in FIG. 12 is arranged at one end of the uniaxial conveyance guide 14. The coupling unit 13 includes the three link members, but the coupling unit 13_2 includes the two link members (the link members 133a and 133b), so that it is possible to prevent an over-constrained state and simplify operation of adjusting the posture and the angle of the inkjet head 16.

Meanwhile, in the painting robot unit 10_2 illustrated in FIG. 12, the coupling unit 13_2 as illustrated in FIG. 12 is arranged at one end of the uniaxial conveyance guide 14, and the coupling unit 13 as illustrated in FIG. 7 is arranged at the other end, but embodiments are not limited to this example. For example, it may be possible to arrange the coupling unit 13_2 as illustrated in FIG. 12 at each end of the uniaxial conveyance guide 14.

### Second Modification

FIG. 13 is a diagram illustrating an example of a configuration of a painting robot unit according to a second modification of the first embodiment. A configuration of a painting robot unit 10_3 according to the second modification of the present embodiment will be described below with reference to FIG. 13.

In one embodiment as described above, as illustrated in FIG. 2, each of the two posture adjustment guides 12 is constituted by a single member having an arch shape. The painting robot unit 10_3 according to the present modification is configured such that one of the two posture adjustment guides 12 is replaced with a posture adjustment guide 12_3 as illustrated in FIG. 13.

The painting robot unit 10_3 includes, as illustrated in FIG. 13, the two conveyance devices 11, the posture adjustment guide 12, the posture adjustment guide 12_3, the coupling unit 13_2, the coupling unit 13_3, the uniaxial conveyance guide 14 (conveyance guide), the head holding unit 15, and the inkjet head 16.

The posture adjustment guide 12_3 includes, as illustrated in FIG. 13, guides 12_3a to 12_3c that are three members having arch shapes. Meanwhile, the posture adjustment guide 12_3 is one example of a “first posture adjustment guide” of an embodiment of the present invention.

A configuration of the coupling unit 13_3 conforms to the configuration of the coupling unit 13 as illustrated in FIG. 7, but the movement members 131a to 131c are movably held by the guides 12_3a to 12_3c, respectively. With this configuration, the movement members 131a to 131c are able to individually move along axial directions of the guides 12_3a to 12_3c.

Meanwhile, other configurations of the painting robot unit 10_3 are the same as the configurations of the painting robot unit 10_2 according to the first modification as described above.

Here, in the coupling unit 13 of the liquid ejection apparatus 1 according to one embodiment as described above, the movement members 131a to 131c move on the single posture adjustment guide 12, and therefore, depending on the posture of the inkjet head 16, the positions of the movement members 131a to 131c may interfere with one another. In contrast, in the coupling unit 13_3 according to the present modification, the movement members 131a to 131c are movably held by the respective guides 12_3a to 12_3c, so that the movement members 131a to 131c are able to individually move on the guides 12_3a to 12_3c and do not interfere with one another regardless of the posture of the inkjet head 16. Therefore, a degree of freedom of the moving range and the posture of the inkjet head 16 increases on the inner sides of the posture adjustment guides 12 and 12_3, so that it is possible to expand the painting range.

Meanwhile, in the painting robot unit 10_3 as illustrated in FIG. 13, the posture adjustment guide 12_3 includes the three guides 12_3a to 12_3c, but configurations are not limited to the above-described configuration as long as the movement members 131a to 131c of the coupling unit 13_3 are able to move independently of one another. For example, a single member included in the posture adjustment guide 12 may have three or more surfaces as side surfaces, and the movement members 131a to 131c may move along different surfaces among the side surfaces. With this configuration, the movement members 131a to 131c are able to move independently of one another, and do not interfere with one another regardless of the posture of the inkjet head 16.

### Third Modification

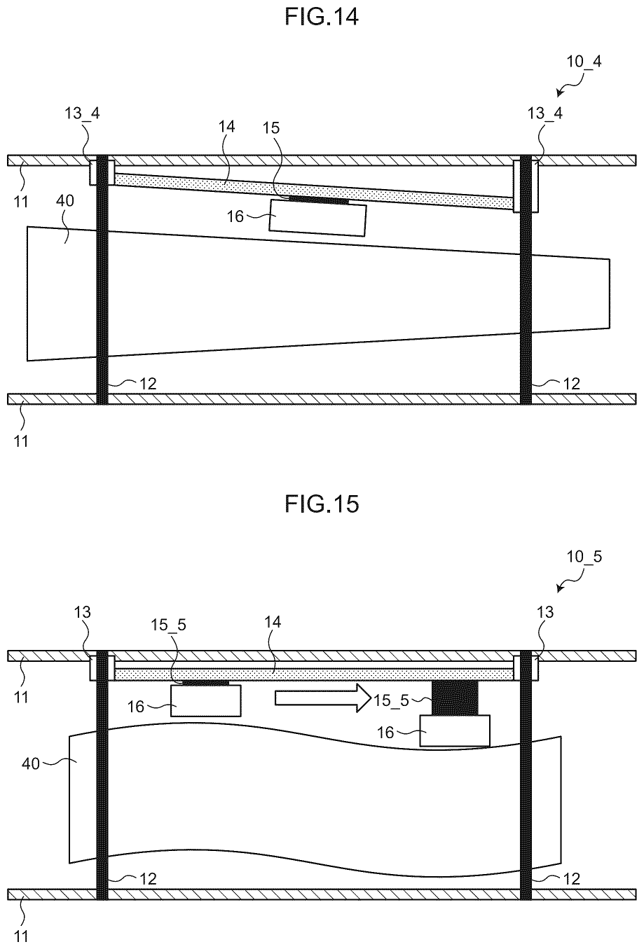

FIG. 14 is a diagram illustrating an example of a configuration of a painting robot unit according to a third modification of the first embodiment. A configuration of a painting robot unit 10_4 according to the third modification of the present embodiment will be described below with reference to FIG. 14. FIG. 14 illustrates the painting robot unit 10_4 viewed from above.

In the painting robot unit 10 according to one embodiment as described above, as illustrated in FIG. 2, the target object 40 that has a surface parallel to the conveying direction of the posture adjustment guides 12 that move on the conveyance devices 11 is explained as a painting target. Furthermore, in the coupling unit 13 as illustrated in FIG. 7, the link members 133a to 133c are configured to rotate, at the corresponding coupling points 132a to 132c, 134a, and 134b, while adopting the direction perpendicular to the extending direction of the posture adjustment guides 12 (a direction viewed in the sheet of FIG. 7) as a central axis.

However, as the target object 40, as illustrated in FIG. 14, it may be possible to adopt an object, as the painting target, that has a surface that is inclined with respect to the conveying direction of the posture adjustment guides 12 that move on the conveyance devices 11. In the present modification, the painting robot unit 10_4 that is able to cope with painting on the target object 40 as described above will be described.

The painting robot unit 10_4 includes, as illustrated in FIG. 14, the two conveyance devices 11, the two posture adjustment guides 12, two coupling units 13_4, the uniaxial conveyance guide 14 (conveyance guide), the head holding unit 15, and the inkjet head 16.

The coupling units 13_4 have configurations that conform to the configuration of the coupling unit 13 as illustrated in FIG. 7 as described above, and, as additional configurations, the link members 133a to 133c of the coupling units 13_4 are able to rotate, at the corresponding coupling points 132a to 132c, 134a, and 134b, while adopting a direction perpendicular to an axial direction (extending direction) of the posture adjustment guides 12 (a direction viewed in the sheet of FIG. 14 in the example illustrated in FIG. 14) as a central axis. Specifically, the coupling units 13_4 are able to adjust the posture and the angle of the inkjet head 16, and further adjust the axial direction of the uniaxial conveyance guide 14. In this case, practically, the two coupling units 13_4 are able to separately adjust distances between end portions of the uniaxial conveyance guide 14 and the posture adjustment guides 12. With this configuration, as illustrated in FIG. 14, the two coupling units 13_4 are able to adjust the axial direction of the uniaxial conveyance guide 14 so as to conform to the inclined surface of the target object 40.

Meanwhile, by only the operation of the link members 133a to 133c of the coupling units 13_4 as described above, an adjustment amount of the distances between the end portions of the uniaxial conveyance guide 14 and the posture adjustment guides 12 is not large, and therefore, the link members 133a to 133c may have their lengths variable. With this configuration, it is possible to increase the adjustment amount of the distances between the end portions of the uniaxial conveyance guide 14 and the posture adjustment guides 12.

### Fourth Modification

FIG. 15 is a diagram illustrating an example of a configuration of a painting robot unit according to a fourth modification of the first embodiment. A configuration of the painting robot unit 10_5 according to the fourth modification of the present embodiment will be described below with reference to FIG. 15. FIG. 15 illustrates the painting robot unit 10_5 viewed from above.

In the painting robot unit 10 according to one embodiment as described above, as illustrated in FIG. 2, the target object 40 that has a surface parallel to the conveying direction of the posture adjustment guides 12 that move on the conveyance devices 11 is explained as a painting target. However, as the target object 40, as illustrated in FIG. 15, it may be possible to adopt an object, as the painting target, that has a surface (for example, a curved surface as illustrated in FIG. 15) that is not parallel to the conveying direction of the posture adjustment guides 12 that move on the conveyance devices 11. In this case, it is difficult to cause the inkjet head 16 to follow the shape of the target object 40 by only causing the inkjet head 16 to move (perform scanning) along the uniaxial conveyance guide 14. In the present modification, a painting robot unit 10_5 that is able to cope with painting on the target object 40 as described above will be described.

The painting robot unit 10_5 includes, as illustrated in FIG. 15, the two conveyance devices 11, the two posture adjustment guides 12, the two coupling units 13, the uniaxial conveyance guide 14 (conveyance guide), a head holding unit 15_5 (one example of the holder), and the inkjet head 16.

The head holding unit 15_5 has a mechanism that is able to hold the inkjet head 16 on the uniaxial conveyance guide 14, and, as illustrated in FIG. 15, adjust a distance between the inkjet head 16 and the uniaxial conveyance guide 14. Therefore, it is possible to adjust the distance between the inkjet head 16 and the target object 40 in accordance with the shape of the surface of the target object 40 when the uniaxial conveyance guide 14 causes the inkjet head 16 to perform scanning, so that it is possible to perform painting in accordance with a surface shape of the target object 40.

Meanwhile, when adjusting the distance between the inkjet head 16 and the target object 40 by the head holding unit 15_5, the adjustment is performed in accordance with painting data that includes shape information on the target object 40. Further, it may be possible to install a sensor that detects a distance to the target object 40 on the inkjet head 16 or the like, and the head holding unit 15_5 may adjust the distance between the inkjet head 16 and the target object 40 in real time based on detection information obtained by the sensor.

### Second Embodiment

A liquid ejection apparatus 1 according to a second embodiment will be described below mainly in terms of differences from the liquid ejection apparatus 1 according to the first embodiment. In the first embodiment, the operation of perform painting on the target object 40 by allowing the inkjet head 16 to perform scanning (movement) by the uniaxial conveyance guide 14 has been described. In the second embodiment, operation of perform painting on the target object 40 by causing the target object 40 to perform scanning with respect to a fixed inkjet head will be described. Meanwhile, a hardware configuration of a painting system 1000 according to the second embodiment and a functional block configuration of a controller 21 according to the second embodiment are the same as the configurations of the first embodiment as described above.

### Configuration of Painting Robot Unit

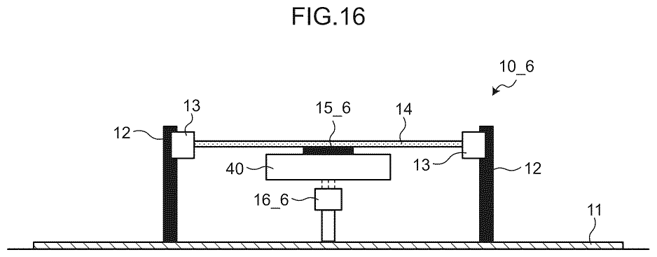

FIG. 16 is a diagram illustrating an example of a configuration of a painting robot unit according to the second embodiment. A configuration of a painting robot unit 10_6 according to the present embodiment will be described below with reference to FIG. 16.

The painting robot unit 10_6 is different from the first embodiment in that an inkjet head 16_6 is fixed and painting is performed by causing the target object 40 to perform scanning. The painting robot unit 10_6 includes, as illustrated in FIG. 16, the two conveyance devices 11, the two posture adjustment guides 12, the two coupling units 13, the uniaxial conveyance guide 14 (conveyance guide), a target object holding unit 15_6 (one example of the holder), and the inkjet head 16_6.

The target object holding unit 15_6 is a member that holds the target object 40 on the uniaxial conveyance guide 14 such that the target object 40 is able to perform scanning by the uniaxial conveyance guide 14.

The inkjet head 16_6 is a liquid ejection head that includes a nozzle surface on which a plurality of nozzles for ejecting a liquid, such as ink, are formed, and is fixed as a pole or the like as illustrated in FIG. 16.

Meanwhile, other configurations of the painting robot unit 10_6 are the same as the configurations of the painting robot unit 10 according to the first embodiment as described above.

In the painting robot unit 10_6 as described above, the coupling units 13 optimally adjust a posture and an angle of the target object 40 with respect to the inkjet head 16_6, and thereafter, the uniaxial conveyance guide 14 causes the target object 40 to perform scanning with respect to the inkjet head 16_6, so that the target object 40 is painted. Meanwhile, scanning of the target object 40 by the uniaxial conveyance guide 14 is one example of operation of moving the inkjet head 16_6 relative to the target object 40.

In the painting robot unit 10_6 according to the present embodiment as described above, by preventing oscillation of the target object 40 at the time of scanning of the target object 40, it is possible to prevent oscillation of the inkjet head 16_6 that occurs when the inkjet head 16_6 moves, so that it is possible to improve painting accuracy.

Meanwhile, it is preferable to adopt the painting robot unit 10_6 according to the present embodiment when a weight or a size of the target object 40 is small enough to be moved by the uniaxial conveyance guide 14. Furthermore, it is possible to adopt, as a liquid ejection method according to the present embodiment, the same method as the first embodiment.

Meanwhile, in each of the embodiments and the modifications as described above, when at least any of the functional units of the controller 21 of the control unit 20 is implemented by execution of a program, the program is provided by being incorporated in a ROM or the like in advance. Furthermore, in each of the embodiments and the modifications as described above, a program that is executed by the controller 21 of the control unit 20 may be provided by being recorded in a computer readable recording medium, such as a Compact Disc Read Only Memory (CD-ROM), a flexible disk (FD), a Compact Disc-Recordable (CD-R), or a Digital Versatile Disc (DVD) in a computer-installable or a computer-executable file format. Moreover, in each of the embodiments and the modifications as described above, a program that is executed by the controller 21 of the control unit 20 may be provided by being stored in a computer coupled to a network, such as the Internet, and downloaded via the network. Furthermore, in each of the embodiments and the modifications as described above, a program that is executed by the controller 21 of the control unit 20 may be provided or distributed via a network, such as the Internet. Moreover, in each of the embodiments and the modifications as described above, a program that is executed by the controller 21 of the control unit 20 has a module structure that includes at least one of the functional units as described above, and as actual hardware, the CPU 211 reads the program from the ROM 212 as described above and executes the program, so that each of the functional units as described above is loaded and generated on a main storage device (the RAM 213).

Embodiments of the present invention are as follows.

According to one aspect of the present invention, it is possible to prevent oscillation of a liquid ejection head that occurs when the liquid ejection head moves, and it is possible to improve painting accuracy.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

What is claimed is:

1. A liquid ejection apparatus comprising:
a liquid ejection head configured to eject a liquid to a target object;
a holder configured to hold the liquid ejection head or the target object;
a conveyance guide configured to allow the liquid ejection head to move with respect to the target object;
a first posture adjustment guide extending in a predetermined extending direction and supporting the conveyance guide, the first posture adjustment guide configured to allow the conveyance guide to move in the extending direction;
a second posture adjustment guide extending in the predetermined extending direction and supporting the conveyance guide, the second posture adjustment guide configured to allow the conveyance guide to move in the extending direction; and
two couplers configured to couple each of the first posture adjustment guide and the second posture adjustment guide to the conveyance guide, wherein
the first posture adjustment guide and the second posture adjustment guide are adjacent to both ends of the conveyance guide and support neighboring portions of the both ends via the two couplers.

2. The liquid ejection apparatus according to claim 1, wherein each of the first posture adjustment guide and the second posture adjustment guide has an arch shape to surround the target object and is supported at both ends of each of the first posture adjustment guide and the second posture adjustment guide.

3. The liquid ejection apparatus according to claim 2, wherein each of the first posture adjustment guide and the second posture adjustment guide includes a combination of at least one arc-shaped members and at least one linear members or includes at least one arc-shaped member only.

4. The liquid ejection apparatus according to claim 1, wherein
one of the two couplers coupling the first posture adjustment guide and the conveyance guide includes
three movement members configured to move along the first posture adjustment guide;
a holding member configured to hold the conveyance guide; and
three coupling members configured to couple each of the three movement members to the holding member,
each of the coupling members is rotatable at a coupling point coupled to the movement member and a coupling point coupled to the holding member, while adopting a direction perpendicular to an axial direction of the first posture adjustment guide as a central axis, and
the coupler coupling the first posture adjustment guide and the conveyance guide makes a distance between the liquid ejection head and the target object and an angle of the liquid ejection head relative to the target object adjustable.

5. The liquid ejection apparatus according to claim 4, wherein two adjacent coupling members among the three coupling members share a coupling point coupled to the holding member.

6. The liquid ejection apparatus according to claim 4, wherein, the three movement members are configured to individually move along the axial direction of the first posture adjustment guide.

7. The liquid ejection apparatus according to claim 4, wherein
another of the two couplers coupling the second posture adjustment guide and the conveyance guide includes
two movement members configured to move along the second posture adjustment guide;
a holding member configured to hold the conveyance guide; and
two coupling members configured to couple each of the two movement members to the holding member,
each of the coupling members is rotatable at a coupling point coupled to the movement member and a coupling point coupled to the holding member, while adopting a direction perpendicular to an axial direction of the second posture adjustment guide as a central axis, and
the coupler coupling the second posture adjustment guide and the conveyance guide makes a distance between the liquid ejection head and the target object and an angle of the liquid ejection head relative to the target object adjustable.

8. The liquid ejection apparatus according to claim 4, wherein the two couplers make a distance between the conveyance guide and the first posture adjustment guide and a distance between the conveyance guide and the second posture adjustment guide separately adjustable.

9. The liquid ejection apparatus according to claim 1, wherein the holder makes a distance between the liquid ejection head and the conveyance guide adjustable.

10. The liquid ejection apparatus according to claim 4, wherein the couplers are configured to, while the liquid ejection head is moved by the conveyance guide, allow the liquid ejection head to move in an ejection direction of the liquid ejection head and maintain a position and an angle of the liquid ejection head relative to the target object.

11. The liquid ejection apparatus according to claim 1, further comprising:
a conveyance device supporting both ends of each of the first posture adjustment guide and the second posture adjustment guide, wherein
the conveyance device is configured to convey the first posture adjustment guide and the second posture adjustment guide in a predetermined direction.
